(19) United States
(12) Patent Application Publication
(10) Pub. No.: US 2009/0002562 A1
(43) Pub. Date: Jan. 1, 2009

(54) Image Processing Device, Image Processing Method, Program for Image Processing Method, and Recording Medium Having Program for Image Processing Method Recorded Thereon

(76) Inventors: Kazuki YOKOYAMA, Kanagawa (JP); Mitsuyasu Asano, Tokyo (JP); Kazuhiko Ueda, Kanagawa (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/972,180

(22) Filed: Jan. 10, 2008

(30) Foreign Application Priority Data
Jan. 17, 2007 (JP) P2007-007789

(51) Int. Cl. H04N 5/14

(52) U.S. Cl. 348/673; 348/E05.062

(57) ABSTRACT

An image processing device for processing input image data includes a contrast correcting section. The contrast correcting section corrects the input image data using image data of a gradient image, which has a luminance gradient in which a luminance level gradually changes, to make a luminance level of the input image data similar to the luminance level of the gradient image.

### CROSS REFERENCES TO RELATED APPLICATIONS

The present invention contains subject matter related to Japanese Patent Application JP 2007-007789 filed in the Japanese Patent Office on Jan. 17, 2007, the entire contents of which are incorporated herein by reference.

### BACKGROUND OF THE INVENTION

1. Field of the Invention

The present invention relates to image processing devices, image processing methods, programs for the image processing methods, and recording media having the programs for the image processing methods recorded thereon, and can be applied to, for example, displays. The present invention gives a depth to a processing-target image by correcting values of pixels of the processing-target image using a gradient image, which has a luminance gradient in which a luminance level gradually changes, to make a luminance level of the processing-target image similar to that of the gradient image.

2. Description of the Related Art

In the related art, image processing devices, such as monitors, make the image quality better by improving the contrast of image data. FIG. 20 is a block diagram showing an exemplary configuration of a contrast correcting section 1 employed in image processing devices of this kind. In a contrast correcting section 1, contrast-improvement-target image data D1 is supplied to a calculating unit 2. The calculating unit 2 corrects values of pixels of the image data D1 with input-output characteristics of correction curves shown in FIGS. 21 and 22, and outputs image data D2.

The correction curve shown in FIG. 21 has an input-output characteristic that increases the contrast at intermediate gray levels. As shown by Equation (1), when the maximum value of a pixel value x of the input image data D1 is denoted by Dmax and the pixel value x of the input image data D1 is currently not greater than ½ of the maximum value Dmax, the calculating unit 2 squares the pixel value x of the input image data D1 using this correction curve, and outputs the output image data D2.

D2=x*x/(Dmax/2) (1)

In contrast, when the pixel value x of the input image data D1 is greater than ½ of the maximum value Dmax, the calculating unit 2 corrects the pixel value x of the input image data D1 according to a characteristic opposite to that used in the case where the pixel value x of the input image data D1 is not greater than ½ of the maximum value Dmax, and outputs the output image data D2 as shown by Equation (2). In such a manner, the contrast at intermediate gray levels is relatively increased by suppressing the contrast at higher and lower luminance levels according to the input-output characteristic of the quadratic curve in the example shown in FIG. 21.

D2=Dmax−(Dmax−x)*(Dmax−x)/(Dmax/2) (2)

On the contrary, a correction curve shown in FIG. 22 has an input-output characteristic that increases the contrast on the black side. As shown by Equation (3), the calculating unit 2 corrects a pixel value x of the input image data D1 using this correction curve so that a change in the corresponding pixel value of the output image data D2 becomes smaller as the pixel value x increases.

D2=Dmax−(Dmax−x)*(Dmax−x)/Dmax (3)

In methods used in the related art, as disclosed in Japanese Unexamined Patent Application Publication Nos. 2004-288186 and 2004-289829, the contrast is improved in detail over a whole image by variously setting a correction curve or dynamically setting a correction curve with reference to an average luminance or a histogram.

However, the contrast improving methods used in the related art may undesirably reduce the depth depending on kinds of images.

### SUMMARY OF THE INVENTION

In view of the above-described points, the present invention suggests an image processing device and an image processing method capable of increasing the depth, a program for the image processing method, and a recording medium having the program for the image processing method recorded thereon.

To this end, an embodiment of the present invention is applied to an image processing device for processing input image data. The image processing device includes a contrast correcting section configured to correct the input image data using image data of a gradient image, having a luminance gradient in which a luminance level gradually changes, to make a luminance level of the input image data similar to the luminance level of the gradient image.

Another embodiment of the present invention is applied to an image processing method for processing input image data. The method includes correcting the input image data using image data of a gradient image, having a luminance gradient in which a luminance level gradually changes, to make a luminance level of the input image data similar to the luminance level of the gradient image.

Still another embodiment of the present invention is applied to a program for allowing a computer to execute an image processing method for processing input image data. The method includes correcting the input image data using image data of a gradient image, having a luminance gradient in which a luminance level gradually changes, to make a luminance level of the input image data similar to the luminance level of the gradient image.

A further embodiment of the present invention is applied to a recording medium having a program that allows a computer to execute an image processing method for processing input image data recorded thereon. The method includes correcting the input image data using image data of a gradient image, having a luminance gradient in which a luminance level gradually changes, to make a luminance level of the input image data similar to the luminance level of the gradient image.

Configurations according to the embodiments of the present invention can provide the luminance gradient corresponding to the gradient image to an image corresponding to the input image data. This luminance gradient gives the depth utilizing human visual characteristic, thereby being able to increase the depth.

Embodiments of the present invention can increase the depth.

### BRIEF DESCRIPTION OF THE DRAWINGS

FIG. 1 is a block diagram showing an image processing module according to an embodiment 1 of the present invention;

FIG. 2 is a block diagram showing a computer according to an embodiment 1 of the present invention;

FIG. 3 is a flowchart showing a procedure executed by a computer shown in FIG. 2;

FIG. 4 is a plan view showing an example of a gradient image;

FIG. 5 is a plan view showing another example of a gradient image;

FIG. 6 is a plan view showing a processing-target image;

FIG. 7 is a plan view showing a processing result;

FIG. 8 is a plan view showing an actual processing result;

FIG. 9 is a plan view showing an original image of a processing result shown in FIG. 8;

FIG. 10 is a plan view showing a gradient image used in processing of FIG. 8;

FIG. 11 is a block diagram showing an image processing module according to an embodiment 2 of the present invention;

FIG. 12 is a block diagram showing a nonlinear filter section included in an image processing module shown in FIG. 11;

FIG. 13 is a block diagram showing a nonlinear smoothing unit shown in FIG. 12;

FIG. 14 is a block diagram showing an image processing module according to an embodiment 3 of the present invention;

FIG. 15 is a block diagram showing a gradient image generating section shown in FIG. 14;

FIG. 16 is a diagram used for explaining generation of a gradient image;

FIG. 17 is a block diagram showing an image processing module according to an embodiment 4 of the present invention;

FIG. 18 is a diagram of a characteristic curve showing a gain in an image processing module shown in FIG. 17;

FIG. 19 is a block diagram showing an image processing module according to an embodiment 5 of the present invention;

FIG. 20 is a block diagram used for explaining a contrast improving method employed in the related art;

FIG. 21 is a diagram of a characteristic curve showing an example of a correction curve; and

FIG. 22 is a diagram of a characteristic curve showing another example of a correction curve.

### DESCRIPTION OF THE PREFERRED EMBODIMENTS

Embodiments of the present invention will be described in detail below with reference to the attached drawings.

### Embodiment 1

### (1) Configuration According to Embodiment 1

FIG. 2 is a block diagram showing a computer 11 according to an embodiment 1 of the present invention. The computer 11 allocates a work area in a random access memory (RAM) 13 according to a record on a read only memory (ROM) 12, and causes a central processing unit (CPU) 14 to execute various kinds of programs recorded on a hard disk drive (HDD) 15. An image processing program for processing of still images is stored in the HDD 15 of this computer 11. Through execution of this image processing program, the computer 11 acquires image data D1 from various kinds of recording media and imaging devices through an interface (I/F) 16, and stores the image data D1 in the HDD 15. The computer 11 also displays an image corresponding to the acquired image data D1 on a display 17, and accepts a user's operation to increase the depth of the image corresponding to this image data.

This image processing program is preinstalled in the computer 11 in this embodiment. Alternatively, the image processing program may be recorded on recording media, such as an optical disc, a magnetic disc, and a memory card, and may be provided to the computer 11. The image processing program may also be provided to the computer 11 through a network, such as the Internet.

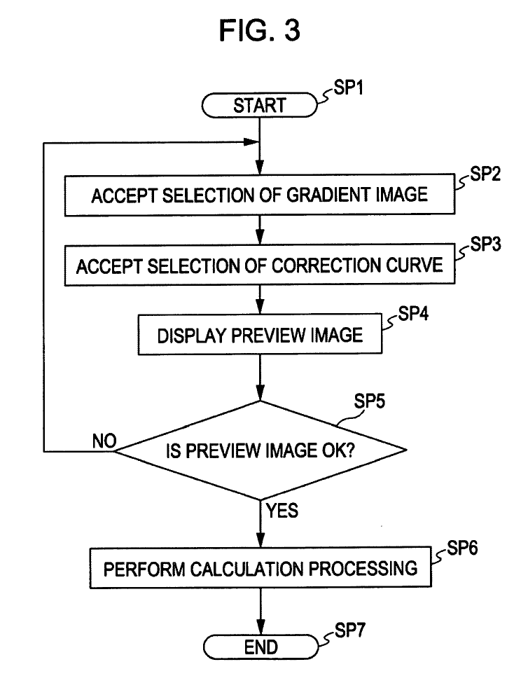

FIG. 3 is a flowchart showing a procedure of this image processing program executed by the CPU 14. The CPU 14 loads processing-target image data D1 specified by a user from the HDD 15, and displays an image corresponding to the image data D1 on the display 17. In response to a user's operation, the CPU 14 displays various kinds of menu on the display 17. Upon receiving a user's selection of a menu to instruct an increase of the depth, the CPU 14 starts the procedure shown in FIG. 3 from STEP SP1, and advances the procedure to STEP SP2. At STEP SP2, the CPU 14 displays a subwindow that shows a plurality of gradient images on the display 17, and accepts a user's selection of a gradient image.

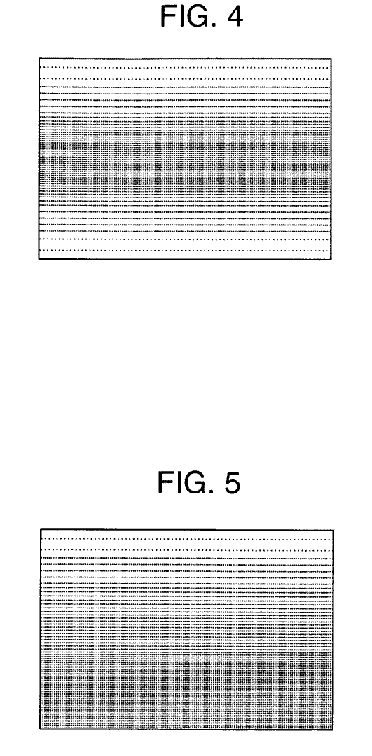

Gradient images have a luminance gradient in which a luminance level gradually changes. In this embodiment, a gradient image includes the same number of pixels as the processing-target image. FIGS. 4 and 5 are plan view showing gradient images having a luminance gradient in the vertical direction. In the gradient image shown in FIG. 4, a line at the center of the screen has the lowest luminance level. The luminance gradient is formed so that the luminance level gradually increases upward and downward from this line. In the gradient image shown in FIG. 5, a line at the bottom has the lowest luminance level. The luminance gradient is formed so that the luminance level gradually increases upward from this line.

In additions to the gradient images shown in FIGS. 4 and 5, other gradient images, such as, for example, one in which the luminance level gradually decreases as a distance from the lower-left end of the screen becomes larger and one in which the luminance level gradually decreases as a distance from the lower-right end of the screen becomes larger, are prepared in this embodiment. At STEP SP2, the CPU 14 accepts the user's selection of a gradient image, used in an increase of the depth, selected from the plurality of prepared gradient images.

At this time, the CPU 14 may accept a user's setting regarding a light source, and then may generate a gradient image in which the luminance level gradually decreases as a distance from the light source becomes larger. In such a manner, the CPU 14 may accept the input of selecting the gradient image. In the case where the depth can be improved sufficiently enough for practical use, the CPU 14 may employ a previously set default gradient image and a step of selecting and inputting an gradient image may be omitted. Since humans psychologically recognize that the light comes from the above, a gradient image in which the luminance level decreases downward from the top of the screen can be employed as the default gradient image.

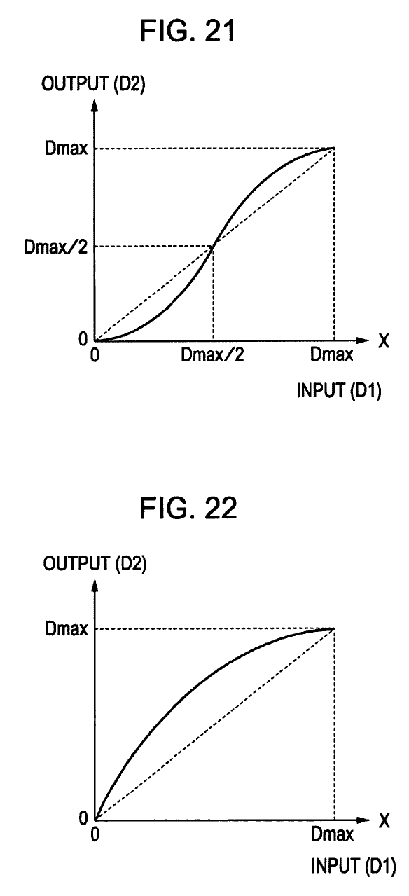

The CPU 14 then advances the process to STEP SP3. At STEP SP3, the CPU 14 displays a plurality of menus showing correction curves in the similar manner, and accepts a user's selection of a correction curve having been described with reference to FIGS. 21 and 22. As described above with reference to FIGS. 21 and 22, the CPU 14 may automatically select and create a correction curve with reference to an average luminance or a histogram.

The CPU 14 then advances the process to STEP SP4. At STEP SP4, the CPU 14 processes the image data D1 of the processing-target image using the gradient image selected at STEP SP2 and the correction curve selected at STEP SP3. The CPU 14 then displays a preview image on the display 17.

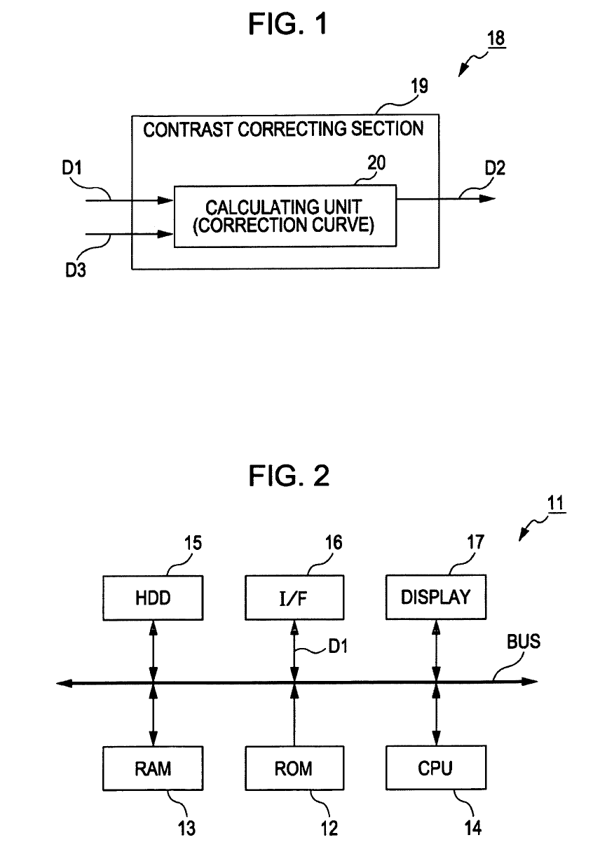

The processing performed on the image data at this time corresponds to processing for giving the depth to the image data D1 using image data D3 of a gradient image to generate image data D2 performed by an image processing module 18, which is a functional block formed by the CPU 14. The image processing module 18 is shown in FIG. 1 by contrast with FIG. 20. More specifically, the CPU 14 supplies interpolated processing-target image data D1 to a calculating unit 20, which is a functional block, provided in a contrast correcting section 19 of this image processing module 18. The CPU 14 also supplies image data D3 of a gradient image that is interpolated in a manner corresponding to the interpolation of the image data D1 to the calculating unit 20. The calculating unit 20 performs a calculation operation using the correction curve selected at STEP SP3 to give the depth to the image data D1.

More specifically, the calculating unit 20 corrects values of pixels of the image data D1 to make the luminance level of the image data D1 similar to the luminance level of the gradient image while improving the contrast. That is, the calculating unit 20 corrects pixel values of the image data D1 so that the luminance level of the image data D1 becomes low at an area where the luminance level of the corresponding gradient image is low and that the luminance level of the image data D1 becomes high at an area where the luminance level of the corresponding gradient image is high while improving the contrast.

More specifically, suppose that the user has selected the correction curve shown in FIG. 21 at STEP SP3 and a pixel value x of the input image data D1 is not greater than ½ of the maximum pixel value Dmax. In such a case, the calculating unit 20 multiplies the pixel value x of the input image data D1 by a pixel value y of the gradient image through a calculation operation represented by Equation (4) corresponding to Equation (1), and outputs the output image data D2.

D2=x*y/(Dmax/2) (4)

In contrast, when the pixel value x of the input image data D1 is greater than ½ of the maximum value Dmax, the CPU 14 corrects the pixel value x of the input image data D1 with the pixel value y of the gradient image according to a characteristic opposite to that used in the case where the pixel value x of the input image data D1 is not greater than ½ of the maximum value Dmax through a calculation operation represented by Equation (5) corresponding to Equation (2), and outputs the output image data D2. In such a manner, the CPU 14 gives the depth to the image corresponding to the image data D1 while increasing the contrast at intermediate gray levels.

D2=Dmax−(Dmax−x)*(Dmax−y)/(Dmax/2) (5)

On the contrary, when the user has selected the correction curve shown in FIG. 22 at STEP SP3, the CPU 14 corrects the pixel value x of the input image data D1 through a calculation operation represented by Equation (6) corresponding to Equation (3) so that a change in the corresponding pixel value of the output image data D2 becomes smaller as the pixel value y of the gradient image increases. In such a manner, the CPU 14 gives the depth to the image corresponding to the image data D1 while increasing the contrast on the darker side.

D2=Dmax−(Dmax−x)*(Dmax−y)/Dmax (6)

The correction of the pixel value x performed at STEP SP 4 may be executed only on a luminance signal component or may be executed on each color signal component of red, green, and blue. After displaying a preview image on the display 17 at STEP SP4, the CPU 14 advances the process to STEP SP5. At STEP SP5, the CPU 14 displays a menu that prompts the user to confirm the preview image on the display 17. Upon the CPU 14 receiving a user's operation performed on the menu to instruct a change of a gradient image or the like, the process returns to STEP SP2. At STEP SP2, the CPU 14 accepts selections of a gradient image and a correction curve again.

On the other hand, if the CPU 14 obtains the user's confirmation at STEP SP5, the CPU 14 advances the process to STEP SP6 from the STEP SP5. At STEP SP6, the CPU 14 executes the same operation performed at STEP SP4 using the image data of all pixels of the processing-target image, and stores the resulting image data D2 in the HDD 15. The CPU 41 then advances the process to STEP SP7, and terminates this procedure.

### (2) Operation According to Embodiment 1

With the above-described configuration, the computer 11 (FIG. 2) stores the image data D1 of a still image received through the I/F 16 in the HDD 15. In response to a user's operation, the computer 11 performs various kinds of image processing on this image data ⊃1. It is possible to improve the contrast through the image processing, such as for example, processing represented by Equations (1) and (2) or processing represented by Equation (3). However, such an improvement in the contrast may undesirably reduce the depth of the image depending on kinds of images.

Accordingly, in response to the user's instruction for an increase of the depth (FIG. 3), the computer 11 accepts selections of a gradient image (FIG. 4 or 5) and a correction curve (FIG. 21 or 22) used in the increase of the depth. The computer 11 corrects pixel values of processing-target image to make the luminance level of the processing-target image similar to the luminance level of the gradient image through the calculation operation (FIG. 1) performed using the gradient image and the correction curve while improving the contrast.

Gradient images have a luminance gradient in which the luminance level gradually changes. Images having such a luminance gradient have a characteristic that allows humans to sense the depth. More specifically, when a line at the center of a gradient image has the lowest luminance level and the luminance level gradually increases upward and downward from this line as shown in FIG. 4, humans sense that an area of the darkest line exists at the deepest location. In addition, when a line at the bottom has the lowest luminance level and the luminance level gradually increases upward from this line, humans sense that an area of the darkest line exists at the deepest or nearest location.

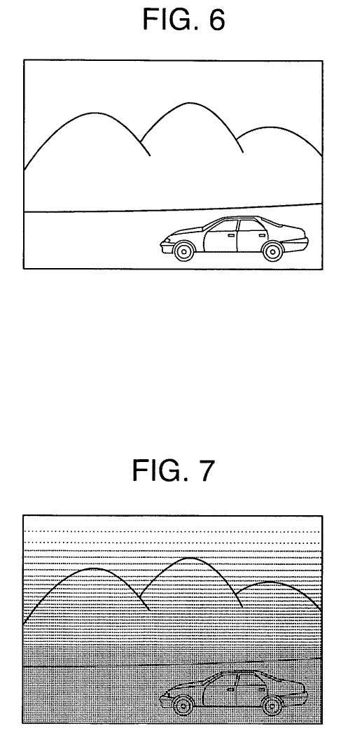

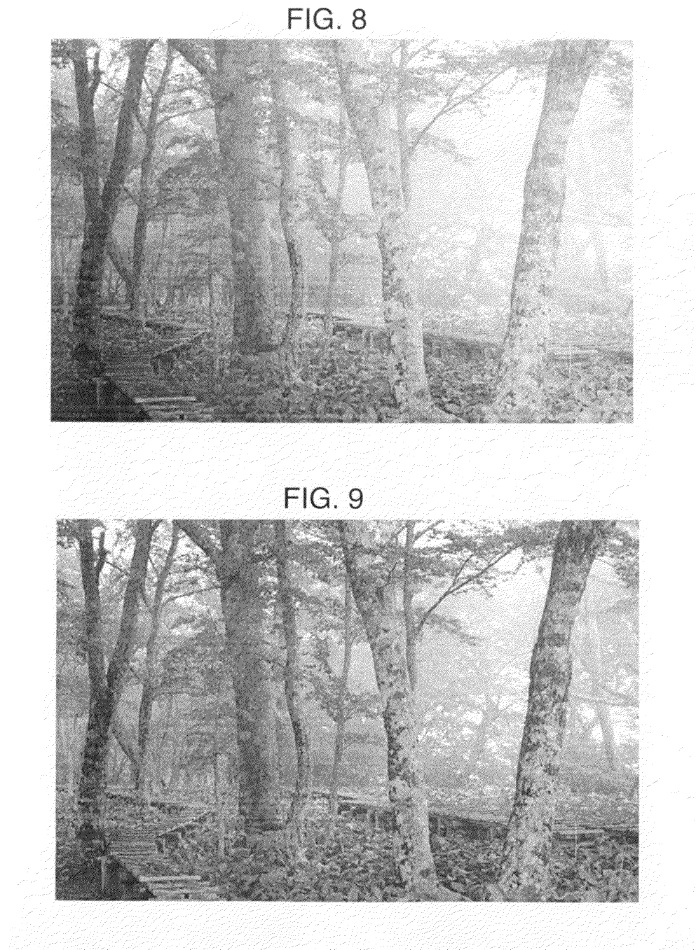

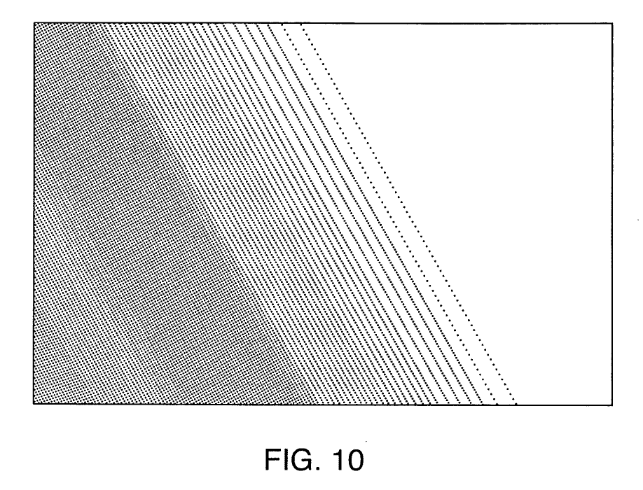

Therefore, by correcting the pixel values of the processing-target image to make the luminance level of the processing-target image similar to the luminance level of such a gradient image, the depth can be given to the processing-target image. More specifically, the depth can be increased by adding the luminance gradient to a scenic photograph barely having the luminance gradient shown in, for example, FIG. 6, so that the luminance level gradually increases upward from the bottom of the image as shown in FIG. 7 by contrast with FIG. 6. FIG. 8 shows an actual processing result. This processing result is obtained by processing a processing-target image shown in FIG. 9 using a gradient image shown in FIG. 10 and a correction curve shown in FIG. 21. It is known from the processing result that addition of the luminance gradient increases the depth.

In addition, it is possible to improve the contrast while also improving the depth according to this embodiment by executing the processing for making the luminance level of the processing-target image similar to the luminance level of the gradient image using a correction curve used in the traditional contrast improvement processing as represented by Equations (4) to (6).

### (3) Advantages According to Embodiment 1

The above-described configuration can give the depth to a processing-target image by correcting pixel values of the processing-target image using a gradient image, which has a luminance gradient in which the luminance level gradually changes, to make the luminance level of the processing-target image similar to the luminance level of this gradient image.

At this time, it is possible to improve the contrast while giving the depth by correcting the pixel values of the processing-target image using a predetermined correction curve.

### Embodiment 2

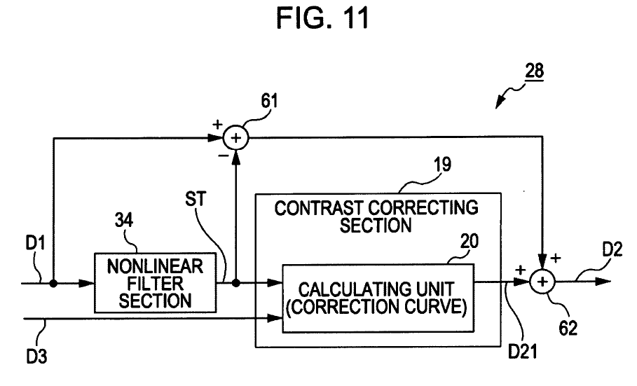

FIG. 11 is a block diagram showing, by contrast with FIG. 1, an exemplary configuration of an image processing module 28 employed in an embodiment 2 of the present invention. A computer according to this embodiment has a configuration similar to that of the computer according to the embodiment 1 excluding the configuration of this image processing module 28.

A nonlinear filter section 34 of this image processing module 28 smoothes image data ⊃1 while preserving edge components, and outputs low frequency components ST of the image data D1. A contrast correcting section 19 improves the contrast while also improving the depth of the low frequency components ST of the image data D1. An adder 62 then adds high frequency components to the low frequency components ST, and outputs output image data D2. This image processing module 28 executes this processing only on luminance signal components of the image data D1. Alternatively, the image processing module 28 may execute this processing on each color signal component of red, green, and blue.

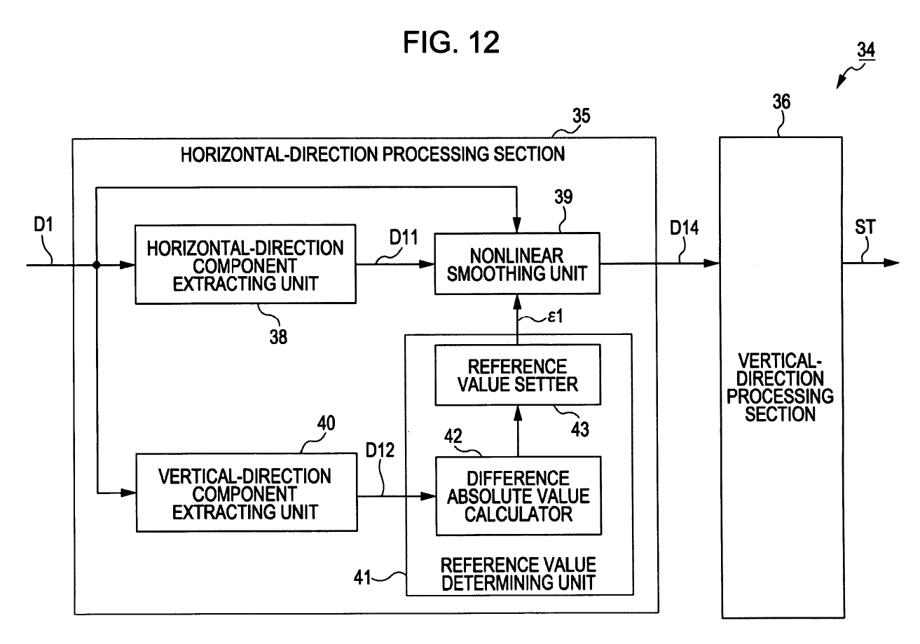

As shown in FIG. 12, a horizontal-direction processing section 35 and a vertical-direction processing section 36 of the nonlinear filter section 34 sequentially perform smoothing processing on the image data D1 in the horizontal and vertical directions, respectively, while preserving edge components.

The horizontal-direction processing section 35 sequentially supplies the image data D1 to a horizontal-direction component extracting unit 38 in an order of raster scan. The horizontal-direction component extracting unit 38 delays this image data D1 using a shift register having a predetermined number of stages. The horizontal-direction component extracting unit 38 simultaneously outputs a plurality of sampled bits of the image data D1 held in this shift register in parallel. More specifically, the horizontal-direction component extracting unit 38 outputs image data D11, sampled at a processing-target sampling point and at a plurality of sampling points adjacent to (in front of and behind) the processing-target sampling point in the horizontal direction, to a nonlinear smoothing unit 39. In such a manner, the horizontal-direction component extracting unit 38 sequentially outputs the image data D11, sampled at the plurality of sampling points and used in the smoothing in the horizontal direction, to the nonlinear smoothing unit 39.

A vertical-direction component extracting unit 40 receives the image data D1 with a line buffer having a plurality of serially-connected stages, and sequentially transfers the image data D1. The vertical-direction component extracting unit 40 simultaneously outputs the image data D1 to a reference value determining unit 41 from each stage of the line buffer in parallel. In such a manner, the vertical-direction component extracting unit 40 outputs image data D12, sampled at the processing-target sampling point of the horizontal-direction component extracting unit 38 and at a plurality of sampling points adjacent to (above and below) the processing-target sampling point in the vertical direction, to a reference value determining unit 41.

The reference value determining unit 41 detects changes in the values sampled at the vertically adjacent sampling points relative to the value sampled at the processing-target sampling point using the image data D12, sampled at the plurality of vertically consecutive sampling points, output from the vertical-direction component extracting unit 40. The reference value determining unit 41 sets a reference value ε1 used in nonlinear processing according to the magnitude of the changes in the sampled values. In such a manner, the reference value determining unit 41 sets the reference value ε1 to allow the nonlinear smoothing unit 39 to appropriately execute smoothing processing.

More specifically, a difference absolute value calculator 42 of the reference value determining unit 41 receives the image data D12, sampled at the plurality of vertically consecutive sampling points, from the vertical-direction component extracting unit 40, and subtracts the value of the image data sampled at the processing-target sampling point from a value of the image data sampled at each of the adjacent sampling points. The difference absolute value calculator 42 then determines absolute values of the differences resulting from the subtraction. In such a manner, the difference absolute value calculator 42 detects absolute values of differences between the value sampled at the processing-target sampling point and the values sampled at the plurality of vertically consecutive sampling points.

A reference value setter 43 detects a maximum value of the absolute values of the differences determined by the difference absolute value calculator 42. The reference value setter 43 adds a predetermined margin to this maximum value to set the reference value ε1. For example, the reference setter 43 may set the margin to 10%, and sets 1.1-fold of the maximum value of the difference absolute values as the reference value ε1.

The nonlinear smoothing unit 39 performs smoothing processing on the image data D11, sampled at the plurality of horizontally consecutive sampling points and output from the horizontal-direction component extracting unit 38, using this reference value ε1. In this processing, the nonlinear smoothing unit 39 determines a weighted average of the smoothing-processing result and the original image data D1 to compensate small edge components that may be lost in the smoothing processing, and outputs the weighted average.

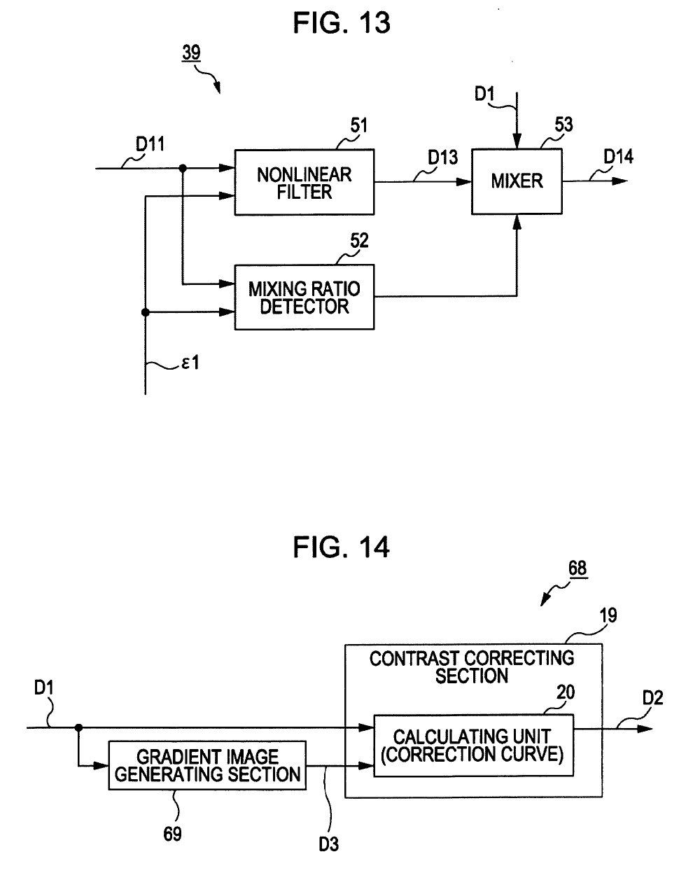

More specifically, as shown in FIG. 13, a nonlinear filter 51 of the nonlinear smoothing unit 39 is an ε-filter. The nonlinear filter 51 determines an average of values of the image data D11, sampled at the plurality of horizontally consecutive sampling points and output from the horizontal-direction component extracting unit 38, using the reference value ε1 output from the reference value determining unit 41. Through this processing, the nonlinear filter 51 smoothes the image data D11 while preserving components whose signal levels changes significantly to exceed the reference value ε1. In such a manner, the nonlinear filter 51 performs averaging processing on the image data D11 in the horizontal direction using the reference value ε1 based on changes in values sampled in the vertical direction while preserving significant changes in signal levels that exceed this reference value ε1.

A mixer 53 determines a weighted average of the image data D13 output from the nonlinear filter 51 and the original image data D1 using a weighting coefficient calculated by a mixing ratio detector 52, and outputs image data D14.

The mixing ratio detector 52 detects changes in signal levels at the sampling points adjacent to the processing-target sampling point in the horizontal direction relative to the signal level at the processing-target sampling point on the basis of the image data D11, sampled at the plurality of horizontally consecutive sampling points and output from the horizontal-direction component extracting unit 38. The mixing ratio detector 52 also detects an existence or absence of a small edge on the basis of the detected changes in signal levels. The mixing ratio detector 52 calculates a weighting coefficient used in the weighted-average determining processing of the mixer 53 on the basis of this detection result.

More specifically, the mixing ratio detector 52 divides the reference value ε1 of the vertical direction detected by the reference determining unit 41 by a predetermined value or subtracts a predetermined value from the reference value ε1 to calculate a reference value ε2 on the basis of the reference value ε1 of the vertical direction. The reference value ε2 is smaller than the reference value ε1. The reference value ε2 is set to allow small edge components smoothed in nonlinear processing performed using the reference value ε1, which is set according to changes in signal levels in the vertical direction, to be detected through comparison of the absolute values of the differences, which will be described later.

Furthermore, the mixing ratio detector 52 receives the image data D11, sampled at the plurality of horizontally consecutive sampling points and output from the horizontal-direction component extracting unit 38. The mixing ratio detector 52 sequentially calculates an absolute value of a difference between the image data at the processing-target sampling point and the image data at each of the rest of sampling points adjacent to the processing-target sampling point. If all of the calculated absolute values of the differences are smaller than the reference value ε2, the mixing ratio detector 52 determines that small edges do not exist.

On the other hand, if at least one of the calculated absolute values of the differences is not smaller than the reference value ε2, the mixing ratio detector 52 further determines whether the sampling point that gives the absolute value of the difference not smaller than the reference value ε2 exists in front of or behind the processing-target sampling point and also determines the polarity of the difference value. If the sampling points that give the absolute values of the difference not smaller than the reference value ε2 exist in front of and behind the processing-target sampling point and the polarities of the differences of the sampling points match, the mixing ratio detector 52 determines small edge components do not exist since the sampled values just temporarily increase due to noises or the like in such a case.

On the other hand, if the sampling point that gives the absolute value of the difference not smaller than the reference value ε2 exists in front of or behind the processing-target sampling point or if the sampling points exist in front of and behind the processing-target sampling point and the polarities of the differences differ, the mixing ratio detector 52 determines that a small edge component exists since the sampled values slightly change in front of and behind the processing-target sampling point.

If the mixing ratio detector 52 determines that a small edge component exists, the mixing ratio detector 52 sets the weighting coefficient used in the weighted-average determining processing performed by the mixer 53 to allow the original image data D1 to be selectively output.

On the contrary, if the mixing ratio detector 52 determines that the small edge component does not exist, the mixing ratio detector 52 sets the weighting coefficient used in the weighted-average determining processing performed by the mixer 53 so that the ratio of components of the image data D13 having undergone the nonlinear processing increases in the image data D14 output from the mixer 53 according to the maximum value of the absolute values of the difference used in the determination based on the reference value ε2. Here, the weighting coefficient is set in the following manner. An increase in the maximum absolute value of the difference linearly increases the weighting coefficient for the image data D13 having undergone the nonlinear processing from 0 to 1.0, for example. If the maximum absolute value of the difference becomes equal to or greater than a predetermined value, the weighting coefficient is set to allow the image data D13 having undergone the nonlinear processing to be selectively output. In such a manner, when the mixing ratio detector 52 determines that an edge does not exist, the mixing ratio detector 52 sets a larger weighting coefficient for the image data having undergone the smoothing processing as the changes in the sampling values become larger, and outputs the image data.

With such a configuration, the horizontal-direction processing section 35 dynamically sets a reference value of the nonlinear filter 51 according to the magnitude of changes in values sampled in the vertical direction, and performs smoothing processing on the image data D1 in the horizontal direction so that a change in sampled values that is equal to or greater than a change in sampled values at vertically adjacent sampling points. The horizontal-direction processing section 35 also detects an edge based on the change in the horizontally sampled value that is smaller than the change in the sampling values at the vertically adjacent sampling points. If such an edge exists, the horizontal-direction processing section 35 selectively outputs the original image data D1. If such an edge does not exists, the horizontal-direction processing section 35 determines a weighted average of the nonlinear processing result D13 and the original image Data D1 according to the magnitude of the change in the horizontally sampled values, thereby performing the smoothing processing on the image data D1 in the horizontal direction while preserving the small edge components.

The vertical-direction processing section 36 (FIG. 12) executes the similar processing in the vertical direction instead of the horizontal direction to perform smoothing processing on the image data D14 output from the horizontal-direction processing section 35. Through this processing, the vertical-direction processing section 36 performs nonlinear processing on the image data D14 in the vertical direction so that a change in the sampled values that is equal to or greater than the change in the values sampled at the horizontally adjacent sampling points is preserved. The vertical-direction processing section 36 also detects an edge based on the change in the vertically sampled values that is smaller than the change in the values sampled at the sampling points adjacent to the processing-target sampling point in the horizontal direction. If such an edge exits, the vertical-direction processing section 36 selectively outputs the original image data D14. If such an edge does not exist, the vertical-direction processing section 36 determines a weighted average of the nonlinear processing result and the original image Data D14 according to the magnitude of the change in the vertically sampled values, thereby performing the smoothing processing on the image data D1 in the vertical direction while preserving small edge components.

The subtractor 61 (FIG. 11) subtracts image data ST output from the nonlinear filter section 34 from the original image data D1, and generates and outputs high frequency components excluding edge components.

The contrast correcting section 19 corrects pixel values of the image data ST output from the nonlinear filter section 34, and outputs image data D21. The adder 62 adds the output data of the subtractor 61 to the output data D21 of the contrast correcting section 19, and outputs the image data D2.

If a characteristic sufficiently enough for practical use can be ensured, low frequency components may be extracted from the image data ⊃1 using an ε-filter, a bilateral filter, or a low-pass filter as the nonlinear filter.

According to this embodiment, advantages similar to those of the embodiment 1 can be obtained without losing high frequency components by extracting low frequency components from image data, correcting pixel values to make the luminance level of a target image similar to the luminance level of a gradient image, and then adding high frequency components to the processed image data.

### Embodiment 3

FIG. 14 is a block diagram showing, by contrast with FIG. 1, an exemplary configuration of an image processing module according to an embodiment 3 of the present invention. This embodiment of the present invention is applied to an image processing device, such as a display, and processes video image data D1. In this case, the image processing module 68 may be configured by software as described above or by hardware.

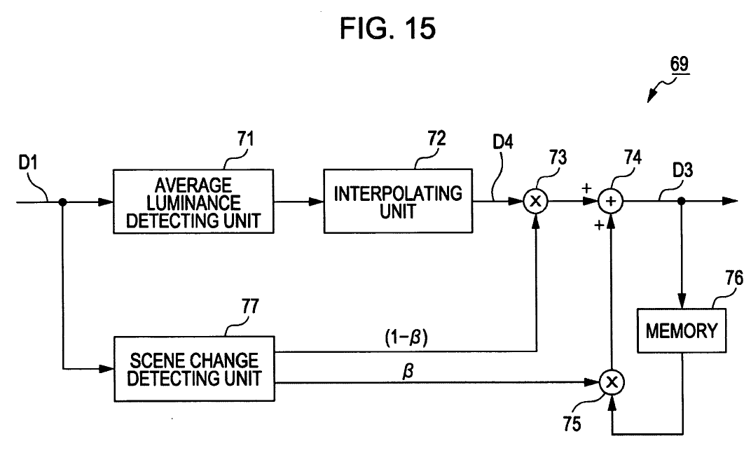

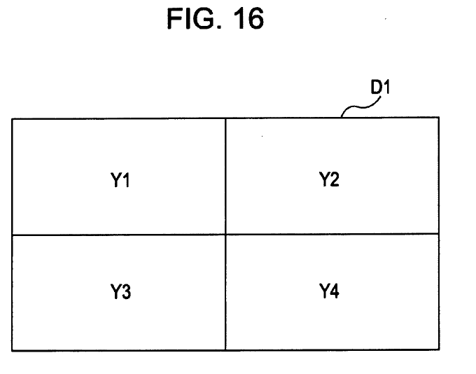

In this embodiment, a gradient image generating section 69 of the image processing module 68 automatically generates a gradient image. As shown in FIG. 15, an average luminance detecting unit 71 of the gradient image generating section 69 receives the image data D1. As shown in FIG. 16, the average luminance detecting unit 71 divides an image corresponding to the image data D1 into a plurality of areas in the horizontal and vertical directions. The average luminance detecting unit 71 calculates average luminance levels Y1 to Y4 for each area. In the example shown in FIG. 16, the processing-target image is divided into two in the horizontal and vertical directions. However, the number of divided areas can be set variously.

An interpolating unit 72 sets a luminance level at the center of each area to the average luminance level calculated by the average luminance detecting unit 71. The interpolating unit 72 performs linear interpolation on the luminance level set at the center of each area to calculate the luminance level of each pixel. In such a manner, the interpolating unit 72 generates image data D4 of a gradient image.

The gradient image generating unit 69 then supplies the image data D4 of the gradient image to a multiplier 73. The multiplier 73 weights the image data D4 with a predetermined weighting coefficient (1-β). An adder 74 is supplied with the weighted image data D4. The adder 74 adds the image data output from a multiplier 75 to the image data D4, and outputs image data D3. A memory 76 of the gradient image generating unit 69 is supplied with the image data D3 output from the adder 74 to delay the image data by one field or one frame. The delayed image data is then supplied to the multiplier 75 and weighted with the weighting coefficient β. In such a manner, the gradient image generating unit 69 smoothes the image data D4 of the gradient image, generated by performing the linear interpolation, using a recursive filter having a feedback factor β, thereby preventing the abrupt change in the gradient image. Here, the feedback factor β is smaller than 1.

A scene change detecting unit 77 receives the image data D1, and detects a sum of absolute values of differences of corresponding pixel values at consecutive fields or frames. The scene change detecting unit 77 examines the sum of the absolute values of differences using a predetermined threshold to detect a scene change. Various methods can be employed in the scene change detection. When the scene change is not detected, the scene change detecting unit 77 outputs the weighting coefficients (1-β) and β to the multipliers 73 and 75, respectively. When the scene change is detected, the scene change detecting unit 77 switches the weighting coefficients output to the multipliers 73 and 75 to 1 and 0, respectively.

Various methods can be employed as the gradient image generating method. For example, a direction having the largest luminance gradient is determined for each area. A position of a light source is estimated by combining the determined directions having the largest luminance gradient. A gradient image may be automatically generated on the basis of the position of the specified light source so that the luminance level gradually decreases as a distance from the estimated light source becomes larger.

This embodiment can be applied to the processing of videos. Advantages similar to those of the embodiment 1 can be obtained by automatically generating a gradient image.

### Embodiment 4

According to the configurations of the above described embodiments, a result of image processing may look unnatural because a luminance gradient may be generated on a subject originally having no luminance gradient. More specifically, for example, a background luminance gradient is generated on a car existing on the front side of the example images shown in FIGS. 6 and 7, which may make the image look unnatural. Accordingly, in this embodiment, an amount of correction of the luminance level is adjusted to be smaller when each pixel value of a gradient image significantly differs from a corresponding pixel value of image data D1.

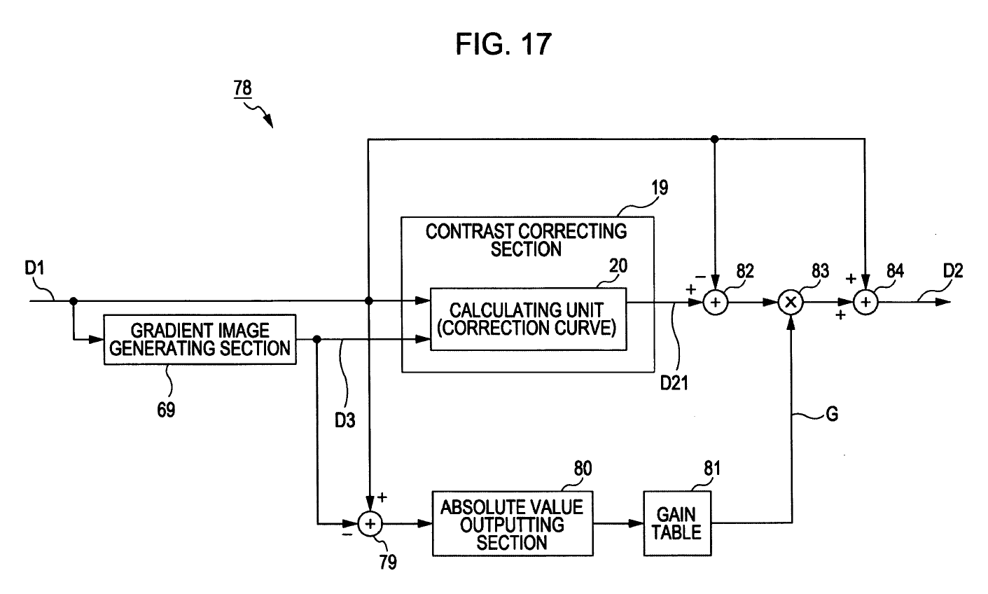

FIG. 17 is a block diagram showing an exemplary configuration of an image processing module according to the embodiment 4 of the present invention. In this image processing module 78, elements similar to those of the image processing modules according to the above-described embodiments are denoted by similar or like reference numerals to omit repeated description.

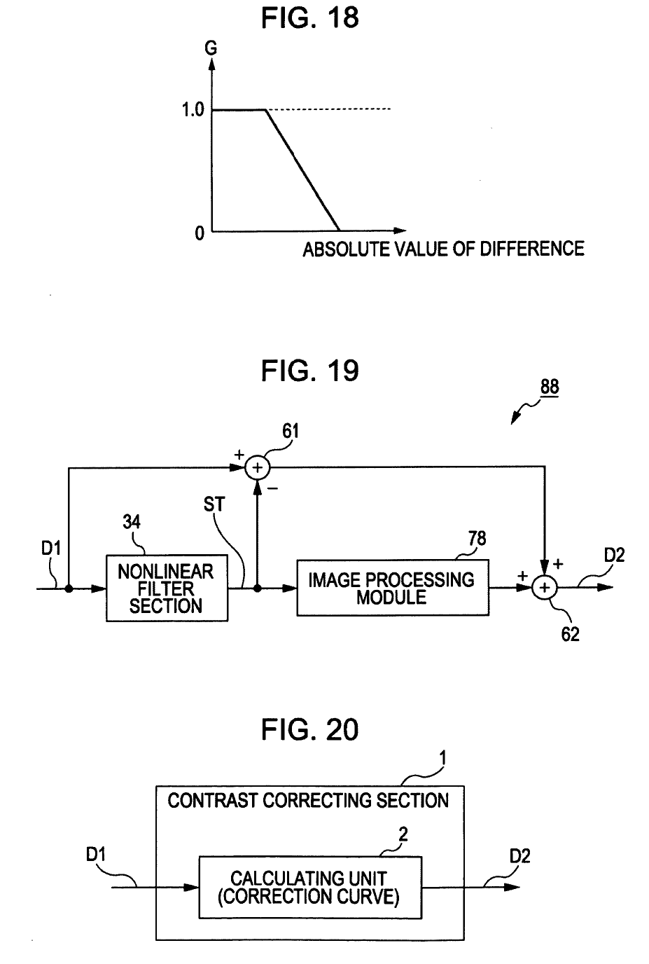

In this embodiment, a subtractor 79 subtracts image data D3 of a gradient image from the processing-target image data D1, and outputs the subtracted value. An absolute value outputting section 80 determines and outputs an absolute value of the subtracted value. A gain table 81 calculates and outputs a gain G whose value gradually decreases from 1 as the absolute value output from the absolute value outputting section 80 becomes larger, for example, as shown in FIG. 18.

A subtractor 82 subtracts the original image data D1 from output data D21 of a contrast correcting section 19, and detects an amount of correction performed by the contrast correcting section 19. A multiplier 83 multiplies the amount of correction determined by this subtractor 82 by the gain G determined by the gain table 81, and outputs the multiplied value. An adder 84 adds the amount of correction corrected by the multiplier 83 to the original image data D1, and outputs image data D2.

According to this embodiment, when each pixel value of a gradient image significantly differs from a corresponding pixel value of the image data ⊃1, an amount of correcting the luminance level is adjusted to be smaller, thereby effectively eliminating the unnaturalness. In such a manner, this embodiment offers advantages similar to those of the above-described embodiments.

### Embodiment 5

FIG. 19 is a block diagram showing an exemplary configuration of an image processing module according to an embodiment 5 of the present invention. This image processing module 88 employs, instead of the contrast correcting section 19 of the image processing module 28 described above regarding the embodiment 2, the image processing module 78 described above regarding the embodiment 4. With this configuration, the image processing module 88 according to this embodiments corrects a luminance level using low frequency components including preserved edge components as in the case of the embodiment 4.

According to this embodiment, high-quality image data processing is performed by correcting the luminance level using low frequency components including preserved edge components as in the case of the embodiment 4. In such a manner, this embodiment offers advantages similar to those of the above-described embodiments.

### Embodiment 6

In the embodiments 3 and 4, the description is given for a case where a gradient image is automatically generated in processing of video images. However, the embodiments of the present invention are not limited to this particular example, and a gradient image may be automatically generated in processing of still images.

In the embodiments 1 and 2, the description is given for a case where a computer processes image data of still images. However, the embodiments of the present invention are not limited to this particular example, and may be widely applied to a case where a computer processes video image data using the configuration of the embodiment 3.

In addition, in the above-described embodiments, the description is given for a case where the depth is given to image data by correcting image data to make the luminance level of the image data similar to that of a gradient image through calculation operations represented by Equations (4) to (6). However, the embodiments of the present invention are not limited to this particular example, and the depth may be given to image data by correcting the image data to make the luminance level of the image data similar to that of a gradient image through other kinds of calculation operations. The following method can be employed as such calculation operations. When a intermediate value of the luminance level of the gradient image or ½ of the maximum luminance level of the gradient image is a value of 0, a correction value is calculated to be in proportion to the luminance level of the gradient image, and this correction value is added to the image data.

In the above-described embodiments, the description is given for a case where the embodiments of the present invention are applied to a computer or a display. However, the embodiments of the present invention are not limited to this particular example, and may be widely applied to various video devices, such as various editing devices and imaging devices.

It should be understood by those skilled in the art that various modifications, combinations, sub-combinations and alterations may occur depending on design requirements and other factors insofar as they are within the scope of the appended claims or the equivalents thereof.

What is claimed is:

1. An image processing device for processing input image data, comprising:
a contrast correcting section configured to correct the input image data using image data of a gradient image, having a luminance gradient in which a luminance level gradually changes, to make a luminance level of the input image data similar to the luminance level of the gradient image.

2. The device according to claim 1, wherein the contrast correcting section partially increases the contrast of the input image data.

3. The device according to claim 1, further comprising:
a separating section configured to separate the input image data into high frequency components and low frequency components; and
an adding section configured to add the high frequency components to output data of the contrast correcting section, wherein
the contrast correcting section corrects the low frequency components to correct the input image data.

4. The device according to claim 1, further comprising:
a gradient image generating section configured to generate image data of the gradient image on the basis of the input image data.

5. An image processing method for processing input image data, comprising:
correcting the input image data using image data of a gradient image, having a luminance gradient in which a luminance level gradually changes, to make a luminance level of the input image data similar to the luminance level of the gradient image.

6. A program for allowing a computer to execute an image processing method for processing input image data, the method comprising:
correcting the input image data using image data of a gradient image, having a luminance gradient in which a luminance level gradually changes, to make a luminance level of the input image data similar to the luminance level of the gradient image.

7. A recording medium having a program recorded thereon, the program allowing a computer to execute an image processing method for processing input image data, the method comprising:
correcting the input image data using image data of a gradient image, having a luminance gradient in which a luminance level gradually changes, to make a luminance level of the input image data similar to the luminance level of the gradient image.
